(19) United States
(12) Patent Application Publication
(10) Pub. No.: US 2017/0348833 A1
(43) Pub. Date: Dec. 7, 2017

(54) Ratchet Wrench System and Kit

(71) Applicant: William P. Curtis, Woodstock, IL (US)

(72) Inventor: William P. Curtis, Woodstock, IL (US)

(21) Appl. No.: 15/610,468

(22) Filed: May 31, 2017

Related U.S. Application Data
(60) Provisional application No. 62/343,990, filed on Jun. 1, 2016.

(51) Int. Cl. B25B 23/00; B25B 13/46; B25G 1/00

(52) U.S. Cl. CPC B25B 23/0035; B25G 1/005; B25B 13/462; B25B 23/0021

(57) ABSTRACT

A ratchet wrench system and kit enable users thereof to enhance grip and mechanical advantage in applying torque to either (a) rotate rotary fasteners or (b) prevent rotary fastener rotation. The ratchet wrench system and kit include at least one ratchet wrench assembly and at least one ratchet interface. The ratchet wrench assembly has a ratchet head and a lever arm. The ratchet head has a male side and a female side. The female side includes both deep and shallow sections. Long and short ratchet interface elements both include a male interface end and a female interface end. The male and female interface ends are respectively matable with the female and male sides of the ratchet wrench assembly. The long and short ratchet interfaces are interchangeably matable with the ratchet wrench assembly for enabling a secondary wrench to grip and enhance mechanical advantage via the ratchet wrench assembly.

### PRIOR HISTORY

This patent application is a non-provisional patent application claiming the benefit of U.S. Provisional Patent Application No. 62/343,990 filed in the United States Patent and Trademark Office on 1 Jun. 2016, the entirety of which is hereby incorporated by reference thereto.

### FIELD OF THE INVENTION

The present invention generally relates to hand tools such as wrench and ratchet wrench assemblies. More particularly the present invention relates to hand tools for enhancing mechanical advantage over rotatory fasteners and the like.

### INVENTION SUMMARY

A ratchet wrench system and kit provide a user with the ability to enhance grip and mechanical advantage in applying torque to either (a) turn rotary fasteners or (b) prevent rotary fasteners from turning. The ratchet wrench system and kit according to the present invention basically and essentially comprise a ratchet wrench assembly, a long ratchet interface, and a short ratchet interface. The ratchet wrench assembly comprises a ratchet head and a lever arm extending from the ratchet head. The ratchet head comprises a male side and a female side. The male side comprises a male transverse cross-section and the female side comprises a deep section and a shallow section.

The long ratchet interface comprises a long male end, a long female end, and a knurled central section. The long male and female ends are respectively and selectively matable with the female and male sides of the ratchet wrench assembly. The knurled central section allows a user to grip the same as a handle for enhancing a user's ability to grip and hold the mated ratchet wrench assembly and the long ratchet interface. The short ratchet interface comprises a short male end and a short female end. The short male and female ends are respectively matable with the female and male sides. The long and short ratchet interfaces enable a secondary wrench to grip and enhance mechanical advantage via the ratchet wrench assembly.

Other components of the ratchet system or kit include a driver adapter element, a ratchet saver plate construction, a half turn double end Allen wrench or hex key, and at least one cheater bar tool as illustrated and described in more detail in the sketches appended to these descriptions.

### BRIEF DESCRIPTION OF THE DRAWINGS

Other objects of the present invention, as well as particular features, elements, and advantages thereof, will be elucidated or become apparent from, the following brief descriptions of drawing figures submitted in support of these specifications.

FIG. 1A is a first top perspective view of a first alternative ratchet wrench assembly according to the present invention.

FIG. 1B is a top perspective view of a first alternative long ratchet interface element according to the present invention.

FIG. 1C is a top perspective view of a first alternative short ratchet interface element according to the present invention.

FIG. 1D is a fragmentary plan view of a male side of first alternative ratchet wrench assembly according to the present invention.

FIG. 1E is a fragmentary plan view of a female side of first alternative ratchet wrench assembly according to the present invention.

FIG. 2 is a second top perspective view of the first alternative ratchet wrench assembly according to the present invention.

FIG. 3A is a top perspective view of the first alternative short ratchet interface element attached atop a second alternative long ratchet interface element according to the present invention.

FIG. 3B is a top perspective view of the first alternative short ratchet interface element according to the present invention.

FIG. 3C is a top perspective view of the second alternative long ratchet interface element according to the present invention.

FIG. 4A is a first top plan view of a fragmentary secondary wrench assembly attached to the first alternative ratchet wrench assembly via the first alternative short ratchet interface element according to the present invention.

FIG. 4B is a first elevational side view of the fragmentary secondary wrench assembly attached to the first alternative ratchet wrench assembly via the first alternative short ratchet interface element with certain parts broken away to show otherwise hidden structure according to the present invention.

FIG. 5A is a second top plan view of a fragmentary secondary wrench assembly attached to the first alternative ratchet wrench assembly via the first alternative short ratchet interface element according to the present invention.

FIG. 5B is a second elevational side view of the fragmentary secondary wrench assembly attached to the first alternative ratchet wrench assembly via the first alternative short ratchet interface element with certain parts broken away to show otherwise hidden structure and engaged with a socket and rotary fastener.

FIG. 6 is a side elevational view of a second alternative ratchet wrench assembly outfitted with a third alternative long ratchet interface element with certain parts broken away to show otherwise hidden structure according to the present invention.

FIG. 7A is a side elevational view of a third alternative wrench assembly according to the present invention.

FIG. 7B is a bottom view of a third alternative wrench assembly according to the present invention.

FIG. 8A is a side elevational view of an angled drive element of the third alternative wrench assembly according to the present invention.

FIG. 8B is a side elevational view of a linear drive element of the third alternative wrench assembly according to the present invention.

FIG. 9A is a side elevational view of a drive element cooperable with a drive adapter element according to the present invention.

FIG. 9B is a side view of the drive adapter element mated with a drive element according to the present invention.

FIG. 9C is a bottom view of the drive adapter element mated with the drive element as otherwise shown in FIG. 9B.

FIG. 10A is a lateral view of a first alternative ratchet saver plate construction according to the present invention.

FIG. 10B is a plan view of the first alternative ratchet saver plate construction according to the present invention.

FIG. 11A is a lateral view of a second alternative ratchet saver plate construction according to the present invention.

FIG. 11B is a plan view of the second alternative ratchet saver plate construction according to the present invention.

FIG. 12A is a side view of a double end key wrench element according to the present invention.

FIG. 12B is a top view of the double end key wrench element according to the present invention mated with a secondary box wrench to add lever arm length to the double end key wrench element.

### DETAILED DESCRIPTION OF THE PREFERRED EMBODIMENTS

Referencing the drawings now with more specificity, the present invention firstly and basically provides a ratchet wrench system kit and method for enhancing grip and mechanical advantage in applying torque to either (a) rotate as at 100 rotary fasteners 31 or (b) prevent rotary fastener 31 rotation 100. Viewed systematically, the ratchet wrench system is believed to essentially comprise a ratchet wrench assembly as at 10 and any number of attachable components cooperable or matable with the ratchet wrench assembly 10. The ratchet wrench assembly 10 preferably comprises a ratchet head 11 and a lever arm 12 extending from the ratchet head 11.

The ratchet head 11 comprises a male side as at 13 and a female side as at 14. The male side 13 preferably comprises a male element as at 15 and the female side preferably comprises at least two female formations, including both a deep section as at 16, and a shallow section as at 17. Sockets as at 30 have female receptors 32 and 53 respectively attachable to the male element 15 and a rotary fastener 31 according to state of the art structures, and the lever arm 11 enables to the user to enhance mechanical advantage in either applying torque to (a) rotate rotary fasteners via a socket as attached to the male element 15 or (b) prevent rotary fastener rotation via a socket as attached to the male element 15.

Among the various contemplated attachable components that are cooperable or matable with the ratchet wrench assembly 10 are a long ratchet interface as at 18. The long ratchet interface 18 may preferably comprise a long interface male end 20, a long interface female end 21, and a central section as at 22, which central section 22 may preferably be outfitted with a knurled outer surface as at 23. The long male interface end 20 and the long female interface end 21 are respectively matable with the female side 14 and the male side 13 of the ratchet head 11. The knurled central section 23 functions to enhance a user's ability to grip and manually hold the mated ratchet wrench assembly 10 and the long ratchet interface 18 by increasing the frictional contact surface area between a user's hand the knurled outer surface 23.

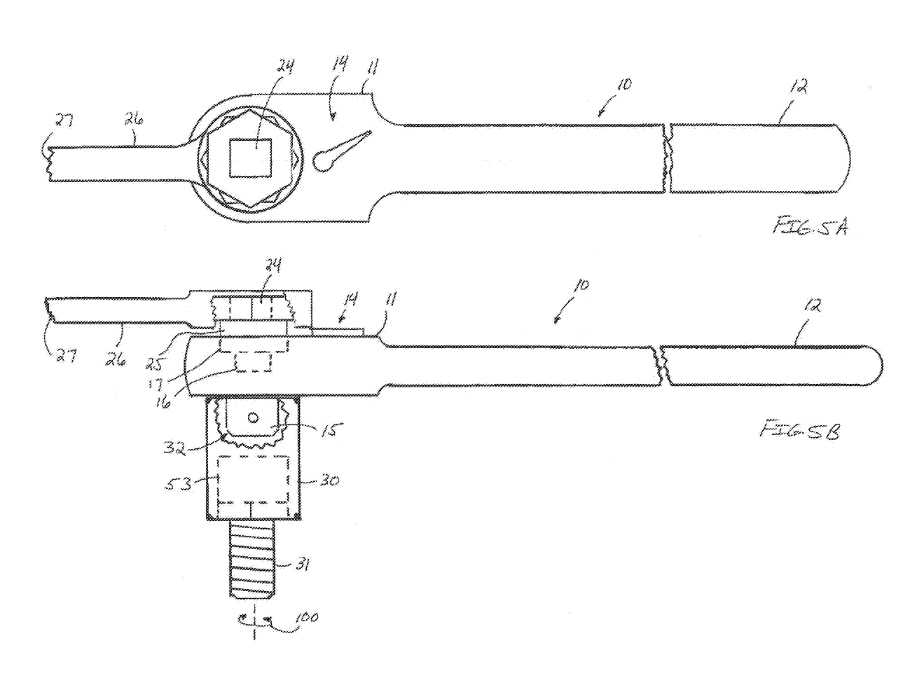

Further among the various contemplated attachable components that are cooperable or matable with the ratchet wrench assembly 10 is a short ratchet interface as at 19. The short ratchet interface 19 may be said to preferably comprise a short male interface end 24, and a short female interface end as at 25. The short male interface end 24 and the short female interface end 25 are respectively matable with the female side 14 and the male side 13 of the ratchet head 11. Together, the long and short ratchet interfaces 18 and 19 enable the user to introduce and couple a secondary wrench assembly as at 26 with secondary lever arm 27 to the ratchet wrench assembly 10 to grip and enhance rotational mechanical advantage relative to a rotary fastener 31 via the ratchet wrench assembly 10 and a socket 30 as generally and comparatively depicted in FIGS. 4A through 5B.

Referencing FIGS. 4A through 5B, it will be seen that the short ratchet interface 19 is oriented such that the short female interface end 25 is received in the shallow section 17 and that the short male interface end 24 is cooperable or matable with the secondary wrench assembly 26 for enabling the user to increase the overall lever arm length by introducing the secondary lever arm 17 to add lever arm length to lever arm 11, and thus enhance rotational mechanical advantage relative to or over the rotary fastener 31.

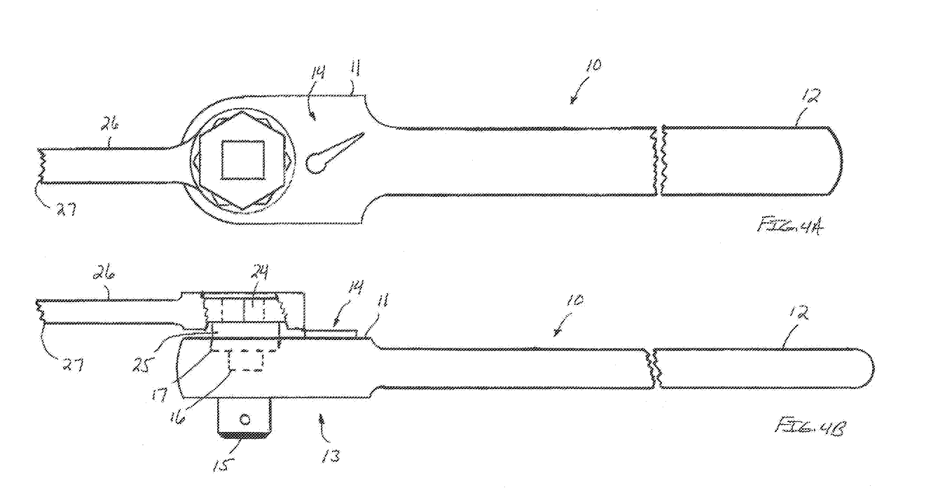

Referencing FIGS. 3A through 3C, the reader will there consider that the long male interface end 20 and the long female interface end 21 of the long ratchet interface 18 are also respectively matable with the short female interface end 25 and the short male interface end 24 of the short ratchet interface 19. FIG. 3A depicts the short ratchet interface 19 attached to or coupled with the long ratchet interface 18 such that the short male interface end 24 is received in the long female interface end. The interchangeability of the short and long ratchet interfaces 19 and 18 thus enable the user to add functionality to the ratchet wrench system according to the present invention.

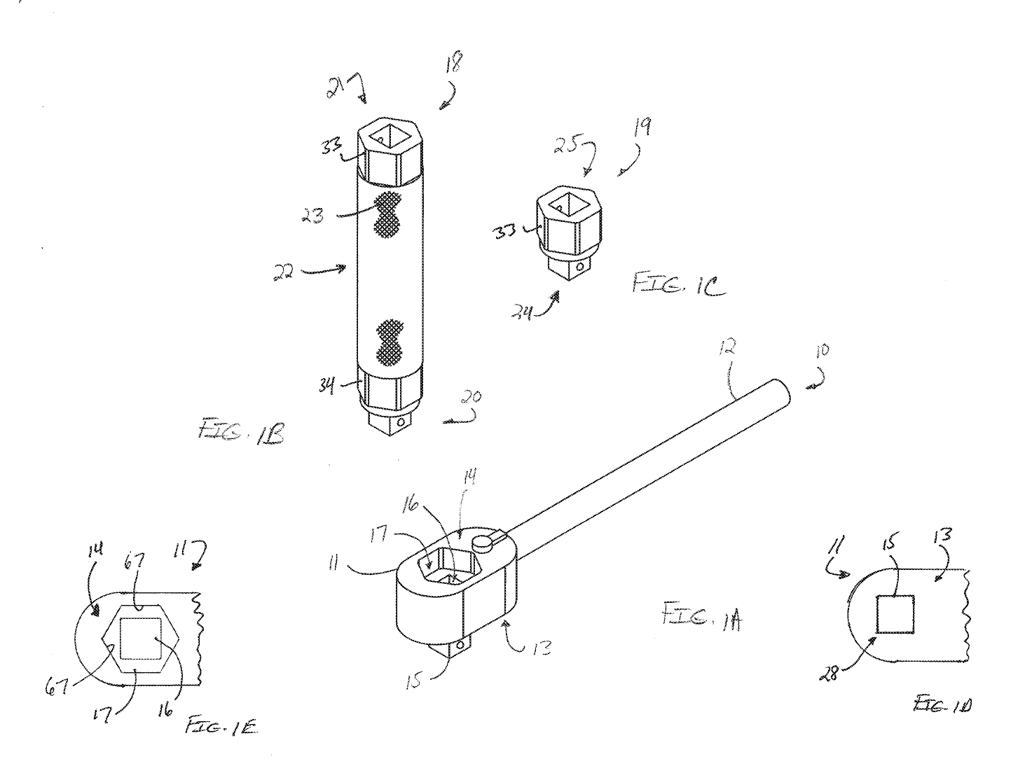

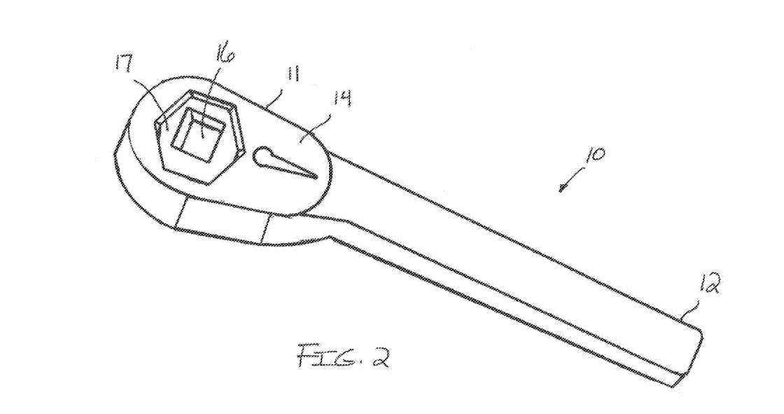

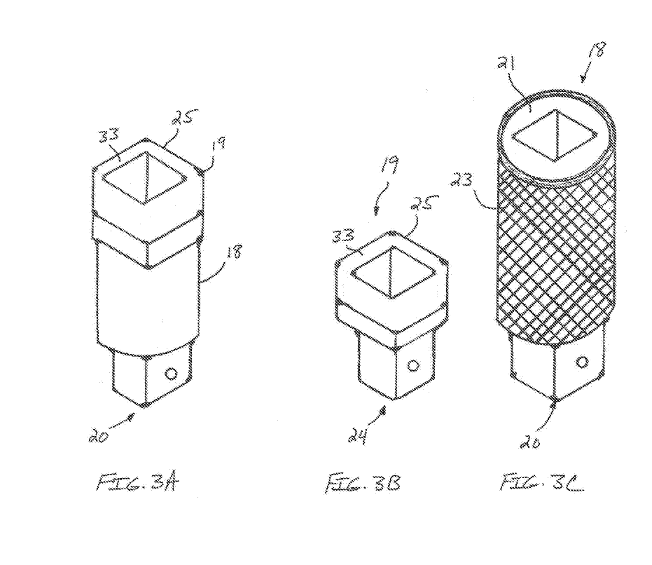

The reader will note that the outer male portions 33 of the short interface element are preferably so that a wrench can more properly cooperate therewith. Further, the outer male portions 33 can be received by female hexagonal shallow section 17 thereby providing a “ratchet saver” meaning the hexagon slides into the female hexagon at shallow section 17 in FIG. 1A. The male end 24 may also be inserted into receptacle 48 of wrench 43 to provide a “breaker bar” as discussed in more detail hereinbelow. Further, the round portion at 22 of the second alternative long interface element 18 comprises a diameter that preferably fits inwardly tangent to the flats 67 of the hexagon shallow section 17 for added stability.

The male element 15 preferably comprises a transverse cross-section having a particular geometric shape exemplified by a square shape 28 as generally depicted in FIG. 1D, and is designed or sized and shaped to mate with female ends 21 and 25 having cooperating transverse shapes (e.g. square as at. Deep section 16 preferably comprises a geometric shape (e.g. square as at 29) and is dimensioned or sized and shaped to mate with the male ends 20 and 24. The shallow section 17 is dimensioned or sized and shaped to mate with (hexagonal) first outer male portions 33 of female ends 21 and 25. The deep section 16 and the shallow section 17 may thus be said to preferably comprise differing shapes. FIGS. 1B and 1C depict the ends 21 and 25 having hexagonal outer male portions 33 and FIGS. 3A and 3B depict end 25 having a square outer male portion 33. The short interface element depicted, for example in FIG. 1C, provides the user with an ability to add leverage with a wrench (Outside) or a driven square (inside). The driven square could be a lithium ion powered electric driver for speed, then final torque by arm force, or alternatively, an air impact gun that has speed and power, the extra power in this case would be from the operator.

Stated another way, the long and short ratchet interfaces 18 and 19 respectively comprise an outer shape as at outer male portion(s) 33 at the long and short female ends 21 and 25, which outer shape enables a secondary wrench 26 to grip and enhance mechanical advantage via the long and short ratchet interfaces 18 and 19. Further, the long ratchet interface 18 comprises an second outer male portion 34 adjacent the long male end 20, which second outer male portion 34 adjacent the long male end 20 is dimensioned or similarly shaped as the outer shape 33 at the long female end 21 for enabling a secondary wrench 26 to grip and enhance mechanical advantage closer to the ratchet head 11 for reducing bending moment.

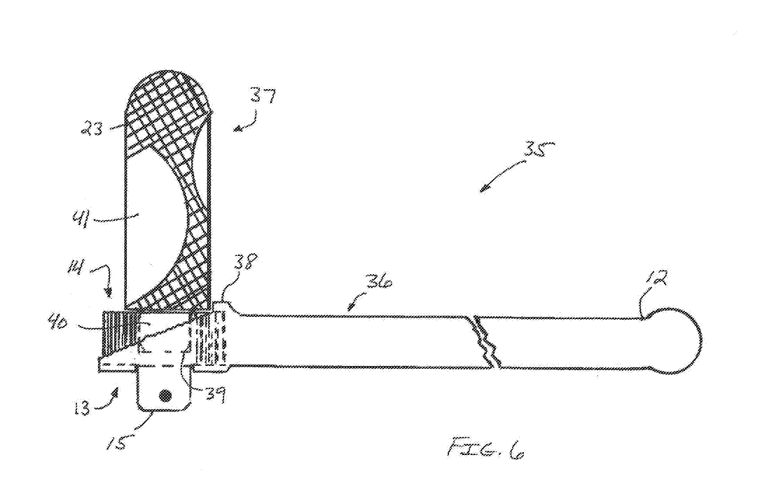

Referencing FIG. 6, the reader will there consider a first alternative ratchet wrench assembly 35 according to the present invention comprising a ratchet wrench 36 and a long ratchet interface 37. The ratchet wrench 36 preferably comprises a ratchet head 38 and a lever arm 12 extending from the ratchet head 38. The ratchet head 38 comprises a male side as at 13 and a female side as at 14. The male side 13 preferably comprises a male element as at 15 and the female side preferably comprises at least one female receptacle or formation as at 39. The long ratchet interface 37 comprises a long male interface end 40, and hand-grippable section as at 41, which hand-grippable section 41 may preferably be outfitted with a knurled outer surface as at 23. The long male interface end 40 is matable with the female side 14.

Referencing FIGS. 7A though 8B, the reader will there consider a second alternative wrench assembly 42 according to the present invention comprising a one-piece wrench construction 43 and an angled interface drive element 44. The wrench construction 43 preferably comprises an interface end 45 and a lever arm 12 extending from the interface end 45. The interface end 45 comprises a male side as at 46 and a female side as at 47. The male side 46 preferably comprises a male element as at 47 and the female side preferably comprises a single female receptacle as at 48. The angled interface drive element 44 comprises a first male end 49 and a second male end 50 angled relative to the first male end 49. The first male end 49 is receivable in or matable at the female side 47. The female side 47 comprises cutout or depression portions 51 configured to structurally accommodate attachable structure (e.g. a socket 30) to mate with the second male end 50.

The second alternative wrench assembly 42 is basically an improved version of what would otherwise be referred to as a “breaker bar” in the industry. The reader is directed in particular to the angled cutout or depression portions 51 which may otherwise be referred to as reliefs for providing clearance for receiving a socket 30. State of the art breaker bars typically comprise or provide a square drive end that pivots 180 degrees. The drive end pivots on a pin extending across a fork formed in the bar. In other words, the end of the bar is an open “U” shape that lets the square drive rotate on the pin that is fixed between to the sides of the open end. The pivot pin and drive end are prone to failure due to the structural arrangement. Second alternative wrench assembly 42, being of uniform or one-piece construction, eliminates this problem.

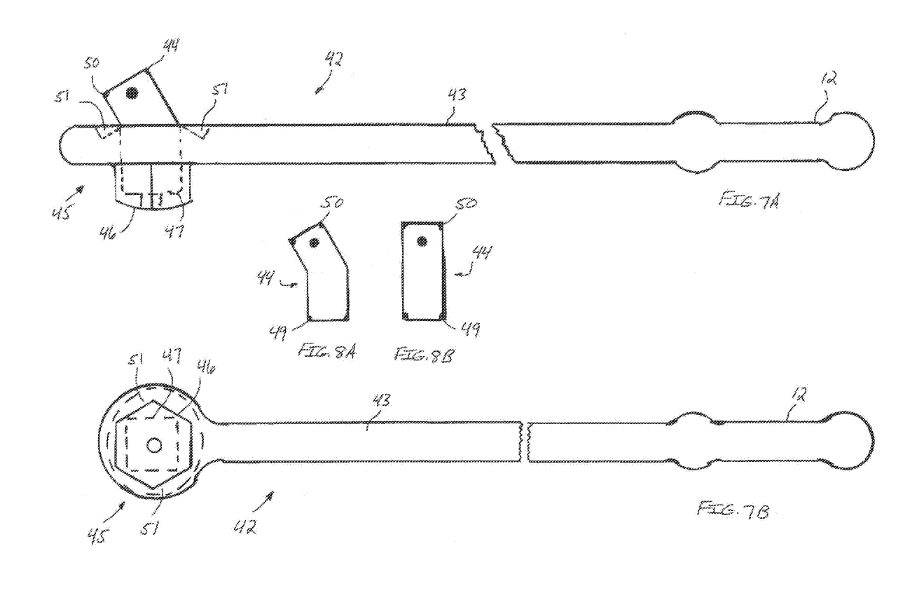

The reader will further consider that the drive element 44 shown in FIG. 8A is an angled square drive element. The angled square drive element 44 can be clocked 4 different directions in the receiver due to the square receptacle 48 and the square transverse cross-section of the drive element 44 at both ends 49 and 50 thereof. The angle of angled square drive element 44 can be provided at virtually any angle. FIG. 8B is a straight or linear square drive pin element and referenced at 44′. If a user should break the drive pin elements 44 or 44′, the user is able to knock out the broken drive pin element 44 or 44′, and save on part replacement costs given the typically unmolested unibody construction of wrench 43 relative to the damaged drive elements 44/44′. A wrench can also attach to the male (hex) element 47, or a tube could slip fit over the male elements to allow someone to maintain the rotary axis in alignment with the bolt centerline.

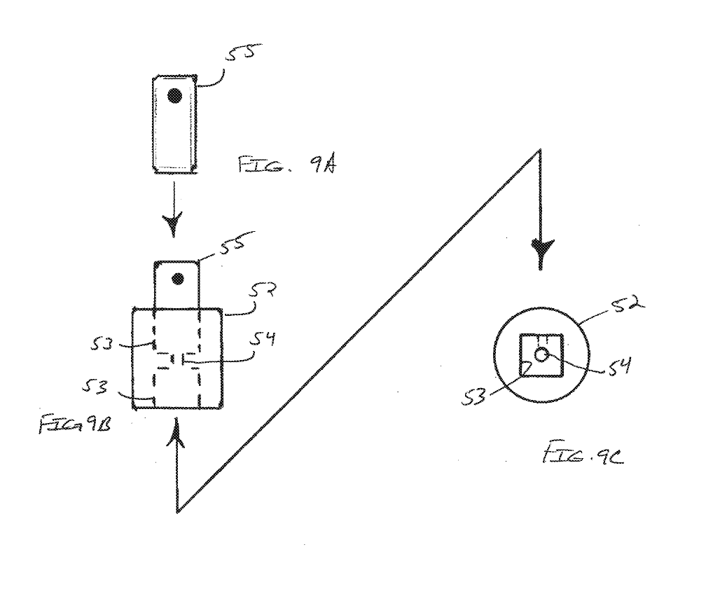

Referencing FIGS. 9A through 9C, the reader will there consider a drive adapter feature according to the present invention. The drive adapter element is generally depicted and referenced at 52 and comprises opposed female receptacles as at 53. Interconnecting the female receptacles is a knock-out hole or bore as at 54 for enabling the user to push-remove a drive bit element 55 receivable in either of the female receptacles 53 sized and shaped to cooperate or mate with male structures exemplified by the various male structures described in these specifications.

The drive adapter element 52 is the author's version of a common adapter. Noting that adapters usually convert a ½ square drive to a ⅜ square drive (or ¾ to ½, ⅜ to ¼, and so on . . . ), it is further noted that the larger (stronger) female side inevitably over stresses and breaks the smaller male side. This typically means the consumer must purchase a replacement tool. The drive adapter element 52 cooperates with replaceable bits 55 in contrast to state of the art adapters. This also allows different male combinations with the same female (main body) portion. The user could also add a fillet radius at the point of larger to smaller square for a stronger male bit that would still allow the socket to fit in position.

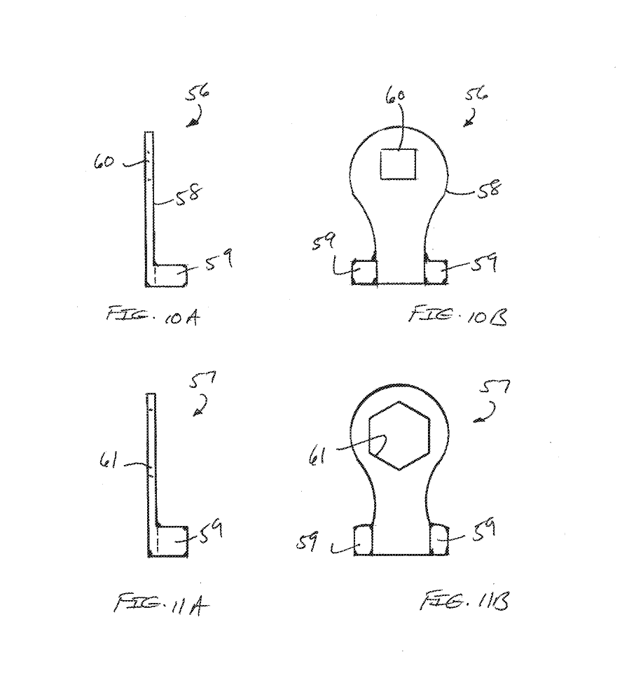

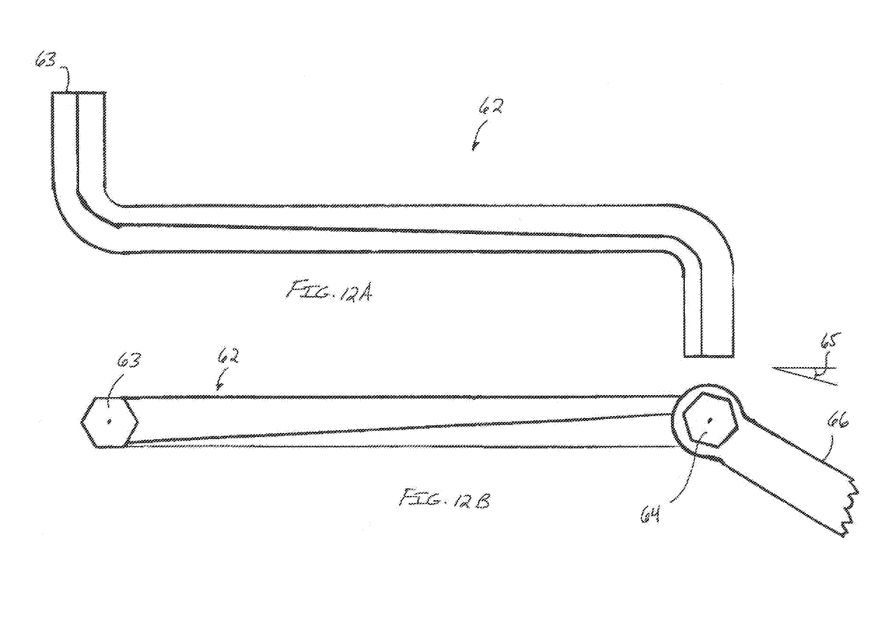

Referencing FIGS. 10A through 11B, the reader will there consider first and second alternative ratchet saver plate constructions as at 56 and 57 respectively. Each ratchet saver plate construction 56 and 57 is outfittable onto an existing ratchet head and comprises an apertured head as at 58 and arm-straddling protrusions as at 59. The ratchet save plate construction 56 comprises a square aperture as at 60 and the ratchet saver plate construction 57 comprises a hexagonal aperture as at 61 for structurally accommodating similarly shaped male structures. The ratchet saver plate constructions are outfittable onto a select ratchet head such that the apertured heads 58 structurally accommodate male structure associated with the select ratchet head and the arm-straddling protrusions 59 straddle a select lever arm extending from the select ratchet head.

Further referencing FIGS. 10A-11B, the reader will consider that when using the ratchet to loosen a “frozen” fastener, the user will maneuver the ratchet sear into the tighten position. This causes the ratchet to . . . “ratchet”, and not apply force to the fastener. Hence the ratchet saver plate constructions operate to lock the square from turning, thereby converting a ratchet head into a “breaker bar”. The aperture 61 in FIG. 11B for example, shows a hexagonal shape to accept a socket or extension that has a male hexagon. The ratchet saver plate constructions 56 and 57 hold the square from turning by holding the socket or extension.

Referencing FIGS. 12A and 12B, the reader will there consider a double end Allen wrench construction as at 62. The double end Allen wrench 62 comprises a hexagonal transverse cross-section with a 15 degree twist between the first end 63 of the Allen wrench 62 and the second end 64 of the Allen wrench 62 such that the hexagonal shape of the transverse cross-section is rotated 15 degrees (as at angle 65) from the first end 63 relative to the second end 64. The Allen wrench 62 thus provides an effective 12 point wrench or key for turning fasteners outfitted with hex receptacles. A box wrench 66 is cooperable with the Allen wrench 62 for enhancing torque by providing a longer lever arm as generally depicted in FIG. 12B.

Stated another way, the present ratchet wrench kit contemplates the inclusion of a double end key wrench construction exemplified by the double end Allen wrench construction 62. The double end key wrench construction comprising opposed key ends as at ends 63 and 64, and a non-circular transverse cross-section at each of the opposed key ends 63 and 64. The non-circular transverse cross-section at a first key end of the opposed key ends is rotated a select rotation degree (e.g. rotational degree or angle 65) relative to a second key end of the opposed key ends thereby effective engagement points for rotating rotatory fasteners 31.

While the above descriptions contain much specificity, this specificity should not be construed as limitations on the scope of the invention, but rather as an exemplification of the invention. For example, it is contemplated that the present invention may essentially be said to provide a ratchet wrench system and kit for enhancing grip and mechanical advantage in applying torque to either (a) rotate rotary fasteners or (b) prevent rotary fastener rotation, the ratchet wrench system and kit may be said to essentially comprise a ratchet wrench assembly and a long ratchet interface.

The ratchet wrench assembly comprises a ratchet head and a lever arm extending from the ratchet head. The ratchet head comprises a male side and a female side. The male side comprises a male element, and the female side comprises at least one female formation. The long ratchet interface comprises a long male interface end and a hand-grippable section. The long ratchet interface comprising a long male interface end and a hand-grippable section. The long male interface end is matable with the female side, and the hand-grippable section enhances a user's ability to grip and hold the ratchet wrench assembly and the long ratchet interface when mated.

The long ratchet interface may further preferably comprise a long female interface end and the hand-grippable section may provide a central section relative to the long male and female interface ends. The long male and female interface ends are preferably and respectively matable with the female and male sides for providing the user with interchangeable component functionality. The female side may further preferably comprise at least two female formations, wherein a first female formation of the at least two female formations is a deep section and a second female formation of the at least two female formations is a shallow section, which deep and shallow sections are configured for receiving first and second male structures.

The ratchet wrench system and kit may further preferably comprise a short ratchet interface having a short male interface end and a short female interface end. The short male and female interface ends are respectively matable with the female and male sides, and the long and short ratchet interfaces are interchangeably matable with the ratchet wrench assembly. The short ratchet interface enables a secondary wrench to grip and enhance mechanical advantage via the ratchet wrench assembly. The male element and the deep section may preferably comprise the same transverse shape, and the deep and shallow sections may preferably comprise differing transverse shapes.

The long and short ratchet interfaces respectively comprise first outer male portions at the long and short female interface ends. The outer male portions at the long and short female interface ends are preferably non-circular in transverse cross-section for enabling a secondary wrench to grip and enhance mechanical advantage via the long and short ratchet interfaces. The long ratchet interface may preferably comprise a second outer male portion adjacent the long male interface end, which second outer male portion adjacent the long male interface end is non-circular in transverse cross-section and the same shape as the outer shape at the long female end for enabling a user to introduce a secondary wrench to grip and enhance mechanical advantage adjacent the ratchet head for reducing bending moment.

The ratchet wrench system and kit may further preferably comprise a second wrench assembly as at wrench assembly 42. The second wrench assembly 42 comprises a one-piece wrench construction 43 and an angled interface element as at 44. The one-piece wrench construction comprises a second interface end and a second lever arm extending from the second interface end. The second interface end comprises second male side and a second female side. The second male side comprises a second male element and the second female side comprises a second female receptacle. The angled interface element comprises a first male end and a second male end angled relative to the first male end. The first male end is matable at the second female side. The second female side comprises depression portions configured to structurally accommodate attachable structure matable at the second male end.

The ratchet wrench system and kit may further preferably comprise a drive adapter element having opposed female receptacles and a knock-out hole interconnecting the opposed female receptacles for enabling the user to push-remove a drive bit element receivable in either of the opposed female receptacles. Further, the ratchet wrench system and kit may preferably include certain ratchet saver plate constructions, each of which has an apertured head and arm-straddling protrusions. The ratchet saver plate constructions are outfittable onto a select ratchet head such that the apertured head accommodates male structure and the arm-straddling protrusions straddle a select lever arm extending from the select ratchet head.

The ratchet wrench system and kit may further preferably include or comprise a double end key wrench construction. The double end key wrench construction comprises opposed key ends and a non-circular transverse cross-section at each of the opposed key ends. The non-circular transverse cross-section at a first key end of the opposed key ends is rotated or offset or twisted a select rotational degree or angle relative to a second key end of the opposed key ends, and thus the double end key wrench construction doubles the effective points for rotating rotatory fasteners.

Accordingly, although the inventive ratchet wrench system and kit has been described by reference to a number of exemplary embodiments, it is not intended that the ratchet wrench system and kit be limited thereby, but that modifications thereof are intended to be included as falling within the broad scope and spirit of the foregoing disclosure, the following claims, and the drawings, both diagrammatic and illustrative, submitted in support of these specifications.

I claim:

1. A ratchet wrench system for enhancing grip and mechanical advantage in applying torque to either (a) rotate rotary fasteners or (b) prevent rotary fastener rotation, the ratchet wrench system comprising:
a ratchet wrench assembly, the ratchet wrench assembly comprising a ratchet head and a lever arm extending from the ratchet head, the ratchet head comprising a male side and a female side, the male side comprising a male element, the female side comprising a deep section and a shallow section;
a long ratchet interface, the long ratchet interface comprising a long male interface end, a long female interface end, and a central section, the long male and female interface ends being respectively matable with the female and male sides, the central section for enhancing a user's ability to grip and hold the ratchet wrench assembly and the long ratchet interface when mated; and
a short ratchet interface, the short ratchet interface comprising a short male interface end and a short female interface end, the short male and female interface ends being respectively matable with the female and male sides, the long and short ratchet interfaces being interchangeably matable with the ratchet wrench assembly for enabling a secondary wrench to grip and enhance mechanical advantage via the ratchet wrench assembly.

2. The ratchet wrench system of claim 1 wherein the male element and the deep section comprise the same transverse shape.

3. The ratchet wrench system of claim 1 wherein deep section and the shallow section comprise differing transverse shapes.

4. The ratchet wrench system of claim 1 wherein the long and short ratchet interfaces respectively comprise first outer male portions at the long and short female interface ends, the outer male portions at the long and short female interface ends being non-circular in transverse cross-section for enabling a secondary wrench to grip and enhance mechanical advantage via the long and short ratchet interfaces.

5. The ratchet wrench system of claim 1 wherein the long ratchet interface comprises an second outer male portion adjacent the long male interface end, the second outer male portion adjacent the long male interface end being non-circular in transverse cross-section for the same shape as the outer shape at the long female end a secondary wrench to grip and enhance mechanical advantage adjacent the ratchet head for reducing bending moment.

6. The ratchet wrench system of claim 1 wherein the second outer male portion adjacent the long male interface end is the same shape as the first outer male portion adjacent the long female interface end.

7. The ratchet wrench system of claim 1 wherein the central section is knurled, the knurled central section for increasing contact surface area of the central section for enhancing grip and mechanical advantage.

8. A ratchet wrench system for enhancing grip and mechanical advantage in applying torque to either (a) rotate rotary fasteners or (b) prevent rotary fastener rotation, the ratchet wrench system comprising:
a ratchet wrench assembly, the ratchet wrench assembly comprising a ratchet head and a lever arm extending from the ratchet head, the ratchet head comprising a male side and a female side, the male side comprising a male element, the female side comprising at least one female formation; and
a long ratchet interface, the long ratchet interface comprising a long male interface end and a hand-grippable section, the long male interface end being matable with the female side, the hand-grippable section for enhancing a user's ability to grip and hold the ratchet wrench assembly and the long ratchet interface when mated.

9. The ratchet wrench system of claim 8 wherein the long ratchet interface comprises a long female interface end and the hand-grippable section is a central section relative to the long male and female interface ends, the long male and female interface ends being respectively matable with the female and male sides for providing the user with interchangeable component functionality.

10. The ratchet wrench system of claim 9 wherein the female side comprises at least two female formations, a first female formation of the at least two female formations being a deep section and a second female formation of the at least two female formations being a shallow section, the deep and shallow sections being configured for receiving first and second male structures.

11. The ratchet wrench system of claim 9 comprising a short ratchet interface, the short ratchet interface comprising a short male interface end and a short female interface end, the short male and female interface ends being respectively matable with the female and male sides, the long and short ratchet interfaces being interchangeably matable with the ratchet wrench assembly, the short ratchet interface for enabling a secondary wrench to grip and enhance mechanical advantage via the ratchet wrench assembly.

12. The ratchet wrench system of claim 11 wherein the long and short ratchet interfaces respectively comprise first outer male portions at the long and short female interface ends, the outer male portions at the long and short female interface ends being non-circular in transverse cross-section for enabling a secondary wrench to grip and enhance mechanical advantage via the long and short ratchet interfaces.

13. The ratchet wrench system of claim 8 wherein the long ratchet interface comprises a second outer male portion adjacent the long male interface end, the second outer male portion adjacent the long male interface end being non-circular in transverse cross-section for enabling a secondary wrench to grip and enhance mechanical advantage adjacent the ratchet head for reducing bending moment.

14. A ratchet wrench kit for enhancing grip and mechanical advantage in applying torque to either (a) rotate rotary fasteners or (b) prevent rotary fastener rotation, the ratchet wrench kit comprising:
a ratchet wrench assembly, the ratchet wrench assembly comprising a ratchet head and a lever arm extending from the ratchet head, the ratchet head comprising a male side and a female side, the male side comprising a male element, the female side comprising at least one female formation; and
a long ratchet interface, the long ratchet interface comprising a long male interface end and a hand-grippable section, the long male and female interface ends being respectively matable with the female and male sides, the hand-grippable section for enhancing a user's ability to grip and hold the ratchet wrench assembly and the long ratchet interface when mated.

15. The ratchet wrench kit of claim 14 comprising a short ratchet interface, the short ratchet interface comprising a short male interface end and a short female interface end, the short male and female interface ends being respectively matable with the female and male sides, the long and short ratchet interfaces being interchangeably matable with the ratchet wrench assembly, the short ratchet interface for enabling a secondary wrench to grip and enhance mechanical advantage via the ratchet wrench assembly.

16. The ratchet wrench kit of claim 14 comprising a second wrench assembly, the second wrench assembly comprising a one-piece wrench construction and an interface drive element, the one-piece wrench construction comprising a second interface end and a second lever arm extending from the second interface end, the second interface end comprising a second male side and a second female side, the second male side comprising a second male element and the second female side comprising a second female receptacle, the interface drive element being matable at the second female side.

17. The ratchet wrench kit of claim 16 wherein the interface drive element is an angled interface drive element, the angled interface drive element comprising a first male end and a second male end angled relative to the first male end, the first male end being matable at the second female side, the second female side comprising depression portions configured to structurally accommodate attachable structure matable at the second male end.

18. The ratchet wrench kit of claim 14 comprising a drive adapter element, the drive adapter element comprising opposed female receptacles and a knock-out hole interconnecting the opposed female receptacles for enabling the user to push-remove a drive bit element receivable in either of the opposed female receptacles.

19. The ratchet wrench kit of claim 14 comprising a ratchet saver plate construction, the ratchet saver plate construction comprising an apertured head and arm-straddling protrusions, the ratchet saver plate construction being outfittable onto a select ratchet head such that the apertured head accommodates male structure and the arm-straddling protrusions straddle a select lever arm extending from the select ratchet head.

20. The ratchet wrench kit of claim 14 comprising a double end key wrench construction, the double end key wrench construction comprising opposed key ends and a non-circular transverse cross-section at each of the opposed key ends, the non-circular transverse cross-section at a first key end of the opposed key ends being rotated a select rotation degree relative to a second key end of the opposed key ends, the double end key wrench construction thus for doubling the effective points for rotating rotatory fasteners.
